(19) United States
(12) Patent Application Publication
(10) Pub. No.: US 2011/0017534 A1
(43) Pub. Date: Jan. 27, 2011

(54) METHOD FOR LOAD POINT DISPLACEMENT DURING HYBRID OPERATION IN A PARALLEL HYBRID VEHICLE

(75) Inventors: Johannes Kaltenbach, Friedrichshafen (DE); Stefan Blattner, Vogt (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/673,669

(22) PCT Filed: Aug. 8, 2008
(86) PCT No.: PCT/EP08/60440

§ 371 Date: Feb. 16, 2010

(30) Foreign Application Priority Data
Aug. 16, 2007 (DE) 10 2007 038 585.6

(51) Int. Cl. B60W 20/00; B60K 6/48

(52) U.S. Cl. 180/65.25; 903/930

(57) ABSTRACT

A method of load point shifting in the hybrid operation of a parallel hybrid vehicle comprising an internal combustion engine, at least one electric machine and an energy accumulator, in which at least one limit curve (A1, B1, C1, D1) is defined in the characteristic map of the specific fuel consumption of the internal combustion engine. At least one limit value (A2, B2, C2, D2) for the energy/charge state is defined for the vehicle energy accumulator, and load point shifting modes (A, B, C, D) are defined, in which the specific fuel consumption of the internal combustion engine and the energy content of the vehicle energy accumulator do not exceed a specified limit curve (A1, B1, C1, D1) or a specified limit value (A2, B2, C2, D2). Load point shifting takes place in one of the load point shifting modes or in a combination of several load point shifting modes.

This application is a National Stage completion of PCT/EP2008/060440 filed Aug. 8, 2008, which claims priority from German patent application serial no. 10 2007 038 585.6 filed Aug. 16, 2007.

### FIELD OF THE INVENTION

The present invention relates to method for load point shifting in the hybrid operation of a parallel hybrid vehicle, comprising an internal combustion engine, at least one electric machine and an energy accumulator.

### BACKGROUND OF THE INVENTION

Hybrid vehicles comprising a hybrid transmission are known from prior art. They comprise, in addition to the internal combustion engine, at least one electric motor or electric machine. In serial hybrid vehicles, a generator is driven by the internal combustion engine, wherein the generator supplies the electric motor driving the wheels with electrical energy. Parallel hybrid vehicles, in which the torques of the internal combustion engine and at least one electrical machine connectable to the internal combustion engine are added, are also known. The electrical machines can be connected to the belt drive or the crankshaft of the internal combustion engine. The torques produced by the internal combustion engine and/or the at least one electrical machine are transferred, via a downstream transmission, to the driven axle.

In DE102006019679 A1, for example, a drivetrain having an electrically adjustable hybrid transmission and an electrohydraulic control system, a plurality of electric power units and a plurality of torque transfer mechanisms is known. In this case, the torque transfer mechanisms can be selectively engaged by the electrohydraulic control system, in order to provide four forward gears, a neutral state, an electrical operating mode with low and high engine speeds, an electrically adjustable operating mode with low and high speeds, and a hill-hold mode.

A hybrid drive unit for vehicles is known from DE 102005057607 B3, containing at least a main engine, in particular an internal combustion engine, a generator, an electric motor and a planetary gear assembly having a sun gear, a ring gear, a planet carrier and planet gears, and containing at least one output shaft. It is provided that, in a first operating range of the vehicle, the drive shafts of the main engine and electric motor are coupled to the sun gear of the planetary gear assembly in order to add up the torques thereof, and in another operating range, one of the two motors can be coupled by a friction fit to the ring gear of the planetary gear assembly in order to add up the engine speeds according to the superimposition principle.

The object of the hybrid operating strategy in hybrid vehicles is the distribution of the driver's desired torque or power to the internal combustion engine and the at least one electric machine when the internal combustion engine and the electric machine are operatively connected or when all clutches are engaged, in a hybrid system having an integrated starter/generator. One part of a hybrid operating strategy is the so-called load point shifting, by which the internal combustion engine can be brought into an operating range having improved fuel consumption on the one hand, and on the other hand, the charge state of the energy accumulator can be influenced.

Load point shifting can be performed as load point raising or load point lowering. In the case of load point raising, the internal combustion engine produces more torque than that desired by the driver, with the at least one electric machine compensating for the difference by operating as a generator, so that the sum of the torques of the internal combustion engine and the electric machine corresponds to the driver's desired torque, and the energy accumulator is charged from fuel energy.

In the case of load point lowering, the internal combustion engine produces less torque than that desired by the driver, with the electric machine compensating for the difference by operating as a motor, so that the sum of the torques of the internal combustion engine and the electric machine corresponds to the driver's desired torque; the energy accumulator is discharged by operating the electrical machine as a motor.

A device and a method for determining the drive power distribution in a hybrid drivetrain of a vehicle is known from the applicant's DE 10 2004 043 589 A1. The known device comprises a unit for determining a target charge state of an energy accumulator in the vehicle that is dependant on the driver's current dynamic or fuel-economical driving mode, as well as for determining the current operating case of the drive train as a function of the target charge state of the energy accumulator. The device further comprises a unit for determining the electrically possible target drive power for the at least one electric machine of the vehicle as a function of the target charge state and the current operating state of the drivetrain, and a unit for determining the target drive power for the internal combustion engine and the at least one electric machine as a function of the electrically possible target drive power.

In the known method for determining the drive power distribution, the driver's desired drive power is detected and the minimum and maximum powers of the internal combustion engine at the current engine speed are determined. In addition, the actual charge state of the energy accumulator and the minimum and maximum charge states are determined, a sportiness value associated with the driver is detected, the minimum and maximum charging powers of the energy accumulator are detected and the minimum and maximum drive powers of the at least one electric machine are determined. Subsequently, a target charge state is calculated from the values for the current desired drive power and the sportiness characteristic value; in addition, the current operating situation of the vehicle is determined as a function of the sportiness characteristic value and the minimum and maximum powers of the internal combustion engine, and the actual charge state of the energy accumulator. It is further provided that an electrically possible target drive power value for the at least one electric machine is determined, wherein with the aid of this value and the minimum and maximum charging powers, and with the aid of the current minimum and maximum drive powers of the at least one electric machine, target drive power values are generated for the at least one electric machine and the internal combustion engine.

In this known method, the characteristic map of the specific fuel consumption of the hybrid vehicle's internal combustion engine is not taken into account.

A method and a device for determining an optimal operating point in vehicles having a hybrid drive with an internal combustion engine and an electric machine is known from DE 10 2005 044 828 A1. Here, operating point data is determined in a first step in a first coordinator using at least one stored characteristic map, and in a second step, the operating point data determined in the first coordinator is optimized in a second coordinator, taking into account the dynamic behavior of the vehicle units.

A method for controlling or regulating the charge state of an energy accumulator or the energy flux in a hybrid vehicle is known from DE 10 2005 044 268 A1, in which the charge state or the energy flux is controlled or regulated as a function of a cost function for the energy consumption or the exhaust emission. In particular, the costs for electrical energy obtained from the energy accumulator, the costs for electrical energy obtained from the internal combustion engine, and the costs for mechanical energy obtained from the energy accumulator and from the internal combustion engine are taken into account in the performance of the method, wherein target torques for the internal combustion engine and the electric machine are determined using a number of energy cost vectors.

In addition, DE 699 32 487 T2 discloses a control/regulation method for a hybrid vehicle in which the current charge state of the energy accumulator is monitored, wherein if this state drops to a threshold, the function of the internal combustion engine is switched from discharging to charging the energy accumulator.

### SUMMARY OF THE INVENTION

The present invention relates to the problem of providing a method for load point shifting in the hybrid operation of a parallel hybrid vehicle, comprising an internal combustion engine, at least one electric machine and an energy accumulator, by the performance of which an operating point of the internal combustion engine with favorable fuel consumption and an optimal charge state of the energy accumulator can be set.

Accordingly, a method for load point shifting in the hybrid operation of a parallel hybrid vehicle, comprising an internal combustion engine, at least one electric machine and an energy accumulator is proposed, in which at least one limit curve is defined in the characteristic map of the internal combustion engine's specific fuel consumption, and at least one limit value for the energy/charge state is defined for the vehicle's energy accumulator, wherein load point shifting modes are defined, in which the specific fuel consumption of the internal combustion engine and the energy content of the vehicle's energy accumulator do not exceed a specified limit curve or a specified limit value. According to the invention, the load point is shifted in one of the load point shifting modes or in a combination of several load point shifting modes.

### BRIEF DESCRIPTION OF THE DRAWINGS

The invention will be explained in greater detail with reference to the appended drawings. The following are shown:

FIG. 1: An example characteristic map of the specific consumption of an internal combustion engine as a function of the torque and the engine speed, and

FIG. 2: A schematic representation of the energy content/charge state of an energy accumulator of a hybrid vehicle, and the energy/charge state limit values defined according to the invention.

### DETAILED DESCRIPTION OF THE PREFERRED EMBODIMENTS

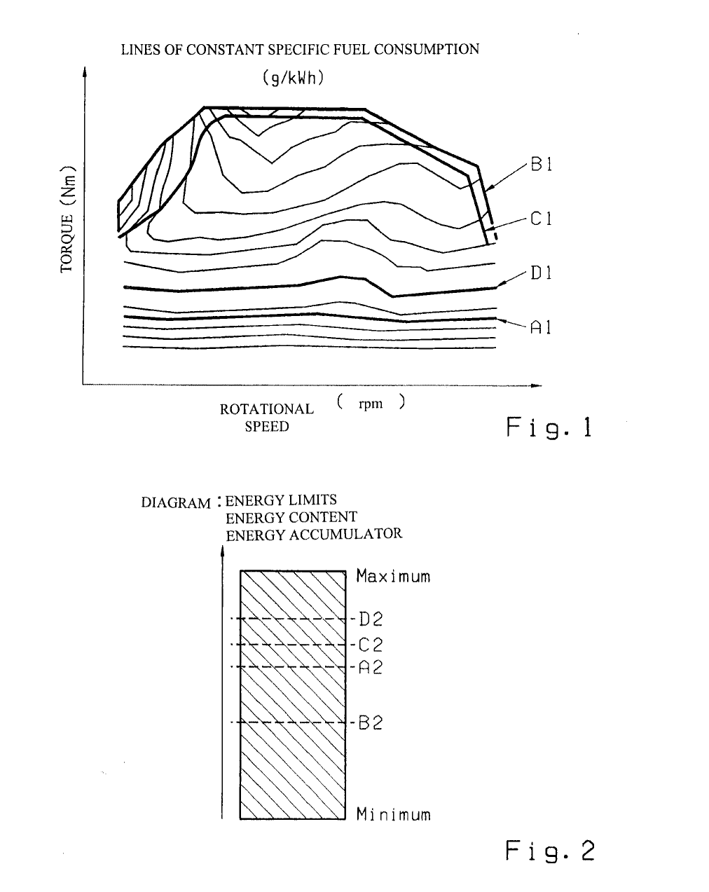

According to the invention, a first load point shifting mode is defined as follows. As shown in FIG. 1, in which the lines of constant specific fuel consumption of the internal combustion engine are also drawn, a limit line A1 in the characteristic map of the specific internal combustion engine fuel consumption is defined that preferably is in a range beyond which the specific fuel consumption of the internal combustion engine no longer improves as sharply by increasing the load as is the case by a load increase from below this line to this line.

If the specific fuel consumption of the internal combustion engine during operation is below the limit line A1, then according to the invention the load point of the internal combustion engine is raised to the limit line A1 in order to reach a range of better specific fuel consumption, with the vehicle's energy accumulator being charged as a side effect.

In an advantageous refinement of the invention, the load point increase for the internal combustion engine is performed only in case of a positive drive demand, which is to say in the direction of vehicle acceleration, with no raising of the point taking place if the internal combustion engine is in a trailing throttle fuel cutoff.

According to the invention, an energy/charge state limit value A2 (SOC limit value) is determined for the vehicle's energy accumulator; this limit value is represented in FIG. 2. The load point raising rate is reduced the closer the charge state of the energy accumulator approaches the energy/charge state limit value A2 (from the bottom in FIG. 2), whereby the charging of the energy accumulator is limited to the limit value A2.

By performing a load point shift according to the load point shifting mode A, a reduction of the internal combustion engine's specific fuel consumption is achieved, while maintaining a specified upper limit for the charge state of the energy accumulator at the same time.

An additional load point shifting mode B is defined according to the invention by defining an energy/charge state limit value B2 (see FIG. 2) of the energy accumulator, wherein the load point of the internal combustion engine is raised in order to charge the energy accumulator, if the current energy content/charge state of the energy accumulator is below the limit value B2.

Here the magnitude of the load increase is preferably proportional to the difference between the limit value B2 and the current energy content/charge state of the energy accumulator; the greater this difference is, the greater is the magnitude of the load increase. The limit value B2 is preferably lower than the limit value A1, as is apparent from FIG. 2. In the load point shifting mode B, the power of the internal combustion engine is limited to a limit curve B1 (see FIG. 1) in the characteristic map of the specific internal combustion engine fuel consumption. The limit curve B1 preferably lies close to the full load line, or the optimal fuel consumption of the internal combustion engine.

By performing a load point shift according to the load point shifting mode B, charging of the vehicle's energy accumulator to a desired energy content with a good specific fuel consumption of the internal combustion engine is achieved.

In a third load point shifting mode C, a limit curve C1 (see FIG. 1) is defined in the characteristic map of the specific internal combustion engine fuel consumption, wherein the load point of the internal combustion engine is lowered to the limit line C1, if the internal combustion engine's specific fuel consumption during operation is above the limit curve C1, in order to reach a range of better specific fuel consumption, with the vehicle's energy accumulator being simultaneously discharged. According to the invention and with reference to FIG. 2, an energy/charge state limit value C2 of the energy accumulator is defined, wherein the load point lowering rate of the internal combustion engine is reduced the more the charge state of the energy accumulator approaches the defined energy/charge state limit value C2 (from above in FIG. 2), so that discharging of the energy accumulator is limited to the limit value C2. By this procedure, a reduction of the internal combustion engine's specific fuel consumption is achieved, while maintaining a specified lower limit for the charge state of the energy accumulator at the same time.

The limit curve C1 preferably is in a range beyond which the specific fuel consumption does not improve at all by decreasing the load, or no longer improves as sharply as it did by decreasing the load from above this curve C1 down to this curve.

In a fourth load point shifting mode D, an energy/charge state limit value D2 of the vehicle's energy accumulator is defined, wherein the load point of the internal combustion engine is lowered, if the current energy content/charge state of the energy accumulator is above the limit value D2, in order to discharge the energy accumulator, and wherein the magnitude of the load lowering is preferably proportional to the difference between the limit value D2 and the current energy content/charge state of the energy accumulator. According to the invention, the power of the internal combustion engine is limited to a limit curve D1 (see FIG. 1) in the characteristic map of the specific internal combustion engine fuel consumption.

The limit curve D1 preferably is in a range in which the specific fuel consumption still has an economically acceptable value (which is to say the specific fuel consumption would substantially increase with a further lowering of the load of the internal combustion engine). By performing a load point shift according to the load point shifting mode D, discharging of the vehicle's energy accumulator to a desired energy content with a good specific fuel consumption of the internal combustion engine is achieved.

According to an advantageous embodiment of the invention, the load point shifting of the internal combustion engine is continuously reduced when the current energy content/charge state of the energy accumulator reaches a defined limit value (A2, B2, C2, D2), in order to avoid a sudden change in the torque or power of the internal combustion engine and/or the electric machine.

The above-mentioned limit curves or limit values A1, B1, C1, D1, A2, B2, C2 and/or D2 are either fixedly defined parameters, or are calculated based on current vehicle parameters, wherein a dependency of these parameters on the vehicle speed is particularly advantageous in order to set aside or reserve space in the vehicle's energy accumulator for recoverable kinetic vehicle energy.

In this particularly advantageous variant of the method according to the invention, it is proposed that load point shifting be performed that results from the sum or the combination of the load point shifting mode A and the load point shifting mode C. Thereby an improvement of the specific fuel consumption of the internal combustion engine is achieved while “passively maintaining” specified energy and/or charge state limits (which is to say the load point shifting is reduced when specified energy limits have been reached or exceeded). In this case, the internal combustion engine is brought into a range of more favorable specific fuel consumption, based on a torque desired by the driver or a desired power, so long as specified charge state limits of the energy accumulator allow it.

According to the invention, load point shifting can be performed that results from the sum or the combination of the load point shifting mode B and the load point shifting mode D. By this procedure, the energy accumulator of the vehicle is always brought into a specified desired range of the charge state so long as the internal combustion engine can remain in a specified range of specified values of specific fuel consumption by way of the necessary load point shift. (“Active maintenance” of specified energy limits while maintaining specified minimum values for the specific internal combustion engine fuel consumption.)

It is further proposed in another particularly advantageous variant of the method according to the invention that load point shifting be performed that results from the sum or the combination of the load point shifting modes A, B, C and D, whereby the advantages of all modes are utilized simultaneously without detrimental mutual influences.

It is particularly advantageous if the efficiency of the at least one electric machine of the vehicle is calculated into or taken into account in the characteristic map of the specific internal combustion engine fuel consumption, whereby an overall efficiency improvement is achieved by taking the internal combustion engine and the electric machine into account. According to the invention, the efficiency of the at least one electric machine may also contain the inverter efficiency.

According to a refinement of the invention, load point shifting is performed only if the achievable improvement of the fuel consumption of the internal combustion engine overcompensates for the energy conversion losses of the vehicle's electrical system, comprising at least one electric machine, at least one inverter, lines and the energy accumulator.

### REFERENCE CHARACTERS

A Load point shifting mode
B Load point shifting mode
C Load point shifting mode
D Load point shifting mode
A1 Limit curve in the characteristic map of the specific internal combustion engine fuel consumption
B1 Limit curve in the characteristic map of the specific internal combustion engine fuel consumption
C1 Limit curve in the characteristic map of the specific internal combustion engine fuel consumption
D1 Limit curve in the characteristic map of the specific internal combustion engine fuel consumption
A2 Limit value for the energy/charge state of the energy accumulator
B2 Limit value for the energy/charge state of the energy accumulator
C2 Limit value for the energy/charge state of the energy accumulator
D2 Limit value for the energy/charge state of the energy accumulator

1-20. (canceled)

21. A method of load point shifting in hybrid operation of a parallel hybrid vehicle, comprising an internal combustion engine, at least one electric machine and an energy accumulator, the method comprising the steps of:
defining at least one limit curve (A1, B1, C1, D1) in a characteristic map of specific fuel consumption of the internal combustion engine;
defining at least one limit value (A2, B2, C2, D2) for an energy/charge state of the energy accumulator of the vehicle;
defining load point shifting modes (A, B, C, D), in which the specific fuel consumption of the internal combustion engine and the energy/charge state of the energy accumulator do not exceed a specified limit curve (A1, B1, C1, D1) or a specified limit value (A2, B2, C2, D2); and
shifting the load point in either one of the defined load point shifting modes (A, B, C, D) or a combination of several of the defined load point shifting modes (A, B, C, D).

22. The method of load point shifting in the hybrid operation of a parallel hybrid vehicle according to claim 21, further comprising the steps of:
defining a first load point shifting mode (A) such that a limit curve (A1) is defined in the characteristic map of the specific internal combustion engine fuel consumption, wherein the load point of the internal combustion engine is raised to the limit curve (A1), if the specific fuel consumption of the internal combustion engine during operation is below the limit curve (A1), to reach a range of better specific fuel consumption and wherein the energy accumulator is simultaneously charged; and
defining an upper energy/charge state limit value (A2) of the energy accumulator of the vehicle such that a load point raising rate of the internal combustion engine is reduced as the energy/charge state approaches the defined upper energy/charge state limit value (A2), such that charging of the energy accumulator is bounded by the upper energy/charge state limit value (A2).

23. The method of load point shifting in the hybrid operation of a parallel hybrid vehicle according to claim 22, further comprising the step of only raising the load point in a positive drive demand, and maintaining the load point, if the internal combustion engine is in a trailing throttle fuel cutoff.

24. The method of load point shifting in the hybrid operation of a parallel hybrid vehicle according to claim 22, further comprising the step of defining the limit curve (A1) as being in a range beyond which the specific fuel consumption of the internal combustion engine is no longer as sharply reduced by increasing load of the internal combustion engine as by a load increase from below the limit curve (A1) up to the limit curve (A1).

25. The method of load point shifting in the hybrid operation of a parallel hybrid vehicle according to claim 21, further comprising the step of defining a second load point shifting mode (B) by defining an energy/charge state limit value (B2) of the energy accumulator, wherein the load point of the internal combustion engine is raised to charge the energy accumulator, if a current energy/charge state of the energy accumulator is below the energy/charge state limit value (B2), such that a magnitude of the load raising is proportional to a difference between the energy/charge state limit value (B2) and the current energy/charge state of the energy accumulator and such that power of the internal combustion engine is bounded by a limit curve (B1) in the characteristic map of the specific fuel consumption of the internal combustion engine.

26. The method of load point shifting in the hybrid operation of a parallel hybrid vehicle according to claim 25, further comprising the step of defining the limit curve (B1) as being close to either a full load line or optimum fuel consumption of the internal combustion engine.

27. The method of load point shifting in the hybrid operation of a parallel hybrid vehicle according to claim 21, further comprising the steps of
defining a third load point shifting mode (C) such that a limit curve (C1) is defined in the characteristic map of the specific fuel consumption of the internal combustion engine, wherein the load point of the internal combustion engine is lowered to the limit line (C1), if the specific fuel consumption of the internal combustion engine during operation is above the limit curve (C1), to reach a range of better specific fuel consumption, and wherein the energy accumulator of the vehicle is simultaneously discharged; and
defining an energy/charge state limit value (C2) of the energy accumulator such that a load point lowering rate of the internal combustion engine is reduced as the energy/charge state of the energy accumulator approaches the defined energy/charge state limit value (C2), such that discharging of the energy accumulator is bounded by the defined energy/charge state limit value (C2).

28. The method of load point shifting in the hybrid operation of a parallel hybrid vehicle according to claim 27, further comprising the step of defining the limit curve (C1) to be in a range beyond which the specific fuel consumption of the internal combustion engine either does not improve at all by lowering the load or no longer improves as sharply as it did when lowering the load from above the limit curve (C1) down to the limit curve (C1).

29. The method of load point shifting in the hybrid operation of a parallel hybrid vehicle according to claim 21, further comprising the step of defining a fourth load point shifting mode (D) by defining an energy/charge state limit value (D2) of the energy accumulator of the vehicle, wherein the load point of the internal combustion engine is lowered to discharge the energy accumulator, if a current energy/charge state of the energy accumulator is above the energy/charge state limit value (D2), wherein a magnitude of the load lowering is proportional to a difference between the energy/charge state limit value (D2) and the current energy content/charge state and wherein power of the internal combustion engine is bounded by a limit curve (D1) in the characteristic map of the specific fuel consumption of the internal combustion engine.

30. The method of load point shifting in the hybrid operation of a parallel hybrid vehicle according to claim 29, further comprising the step of defining the limit curve (D1) as being in a range in which the specific fuel consumption of the internal combustion engine has an economically acceptable value, wherein the specific fuel consumption of the internal combustion engine would substantially increase with further lowering of the load of the internal combustion engine.

31. The method of load point shifting in the hybrid operation of a parallel hybrid vehicle according to claim 21, further comprising the step of continuously reducing the load point shifting of the internal combustion engine when a current energy content/charge state of the energy accumulator reaches a defined limit value (A2, B2, C2, D2), to avoid a sudden change in either torque or power of at least one of the internal combustion engine and/or the electric machine.

32. The method of load point shifting in the hybrid operation of a parallel hybrid vehicle according to claim 21, further comprising the step of defining at least one of the limit curves (A1, B1, C1, D1) and the limit values (A2, B2, C2, D2) as fixed parameters.

33. The method of load point shifting in the hybrid operation of a parallel hybrid vehicle according to claim 21, further comprising the step of dynamically calculating at least one of the limit curves (A1, B1, C1, D1) and the limit values (A2, B2, C2, D2) based on current vehicle parameters.

34. The method of load point shifting in the hybrid operation of a parallel hybrid vehicle according to claim 33, further comprising the step of calculating at least one of the limit curves (A1, B1, C1, D1) and the limit values (A2, B2, C2, D2) as a function of vehicle speed, with space being reserved in the energy accumulator for recoverable kinetic vehicle energy.

35. The method of load point shifting in the hybrid operation of a parallel hybrid vehicle according to claim 21, further comprising the step of either calculating or considering the efficiency of the at least one electric machine of the vehicle in the characteristic map of the specific fuel consumption of the internal combustion engine, whereby an overall efficiency improvement is achieved by taking the internal combustion engine and the electric machine into account.

36. The method of load point shifting in the hybrid operation of a parallel hybrid vehicle according to claim 35, wherein considering inverter efficiency in the efficiency of the at least one electric machine.

37. The method of load point shifting in the hybrid operation in a parallel hybrid vehicle according to claim 21, further comprising the step of only performing load point shifting, if an achievable improvement of the fuel consumption of the internal combustion engine overcompensates for energy conversion losses of an electrical system of the vehicle, comprising at least one electric machine, at least one inverter, lines and the energy accumulator.

38. The method of load point shifting in the hybrid operation of a parallel hybrid vehicle according to claim 21, further comprising the step of combining a first load point shifting mode (A) with a third load point shifting mode (C).

39. The method of load point shifting in the hybrid operation of a parallel hybrid vehicle according to claim 21, further comprising the step of combining a second load point shifting mode (B) with a fourth load point shifting mode (D).

40. The method of load point shifting in the hybrid operation of a parallel hybrid vehicle according to claim 21, further comprising the step of combining a plurality of the load point shifting modes (A, B, C, D) with one another.
